(19) United States
(12) Patent Application Publication
(10) Pub. No.: US 2013/0185626 A1
(43) Pub. Date: Jul. 18, 2013

(54) METHOD, TERMINAL AND COMPUTER-READABLE RECORDING MEDIUM FOR COMPILING JAVASCRIPT INCLUDED IN WEB APPLICATION USING Ahead-Of-Time (AOT)

(71) Applicants: Se Kwon Jang, Gyeonggi-do (KR); Jwa Jin Kim, Seoul (KR); Jae Yong Lim, Seoul (KR)

(72) Inventors: Se Kwon Jang, Gyeonggi-do (KR); Jwa Jin Kim, Seoul (KR); Jae Yong Lim, Seoul (KR)

(73) Assignee: OBIGO INC., Seoul (KR)

(21) Appl. No.: 13/425,582

(22) Filed: Mar. 21, 2012

(30) Foreign Application Priority Data
Jan. 13, 2012 (KR) 10-2012-0004329
Feb. 20, 2012 (KR) 10-2012-0017154

(51) Int. Cl. G06F 17/00

(52) U.S. Cl. 715/234

(57) ABSTRACT

The present invention relates to a method for compiling JavaScript included in a web application ahead of time (AOT). The method includes the steps of: (a) allowing a user terminal to acquire and unpackage the web application; and (b) allowing the user terminal to compile JavaScript included in the web application by referring to a platform thereof and create a form of machine code executable thereon, before the web application runs thereon. In accordance with the present invention, JavaScript included in the web application can be compiled in the form of machine code executable on a platform of the user terminal by referring to the platform where the web application is able to run.

### CROSS-REFERENCE TO RELATED APPLICATIONS

This application claims priority to and the benefit of Korean Patent Application No. 10-2012-0004329 filed in the Korean Intellectual Property Office on Jan. 13, 2012 and to Korean Patent Application No. 10-2012-0017154 filed in the Korean Intellectual Property Office on Feb. 20, 2012, the entire contents of which are incorporated herein by reference.

### STATEMENT REGARDING THIRD PARTY RESEARCH PROJECT

This invention was made with Korean government support under Project No. 10039299 with 100% contribution sponsored by the Ministry of Knowledge Economy, Republic of Korea under Research Project Title: Innovative Industrial Original Technology Development Project; Subject Title Development of AOT-based compiler and Web Runtime platform for the purpose of enhancing the Javascripting speed in mobile devices. The Research Management Institute is the Korea Evaluation Institute of Industrial Technology. The research period runs from May 1, 2011 through Apr. 30, 2013. The beneficiary of said sponsorship is Obigo, Inc.

### FIELD OF THE INVENTION

The present invention relates to a method, a terminal, and a computer-readable recording medium for compiling JavaScript included in a web application; and more particularly, to the method, the terminal, and the computer-readable recording medium for speeding up an execution of the web application on a user terminal by (i) ahead-of-time (AOT) compiling JavaScript included in the web application by reference to a platform of the user terminal and (ii) creating machine code executable thereon before the web application runs thereon.

### BACKGROUND OF THE INVENTION

Recently, due to the widespread use of users' terminals such as smart phones or tablet PCs, a variety of applications that may run on such terminals and implement a lot of functions are introduced. More interest has been paid recently to web applications which may run on any kinds of terminals regardless of types of platforms thanks to standard web languages than to native applications executable only on terminals where specified platforms, i.e., operating systems such as Apple iOS and Google's Android OS are installed.

By the way, to run programmed web apps based on standard web languages, a technology for compiling a standard web application, particularly, JavaScript may be desperately required.

As a technology for just-in-time (JIT) compiling JavaScript, a JIT compilation has been conventionally introduced. The JIT compilation is a method for compiling JavaScript and transforming it into machine code when a web application runs to improve the performance of a JavaScript engine. According to the aforementioned JIT compilation, the method has a benefit for maintaining neutrality from platforms installed on a user terminal. Because JavaScript is compiled at the same time as the web application runs, it requires longer time to execute the web application due to the increase of the time for doing the JavaScript compilation. As a result, the performance of the web application becomes deteriorated.

Therefore, the inventor came to invent a new technology for compiling JavaScript to solve the problems of the existing technology.

### SUMMARY OF THE INVENTION

It is an object of the present invention to solve the problems mentioned above.

It is another object of the present invention to AOT compile JavaScript included in a web application and create a form of machine code immediately executable on a user terminal before the web application runs thereon.

It is still another object of the present invention to compile the JavaScript included in the web application to the form of machine code executable on a platform of the user terminal by referring to the platform where the web application is able to run.

It is an object of the present invention to provide a method for compiling JavaScript included in a web application ahead of time (AOT), including the steps of: (a) allowing a user terminal to acquire and unpackage the web application; and (b) allowing the user terminal to compile JavaScript included in the web application by referring to a platform thereof and create a form of machine code executable thereon, before the web application runs thereon.

It is another object of the present invention to provide a terminal for compiling JavaScript included in a web application ahead of time (AOT), including: a web application managing part for unpackaging an acquired web application; and a compilation performing part for compiling JavaScript included in the web application by referring to its platform before the web application runs and creating a form of machine code executable on its platform.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing approximately representing a configuration of a whole system to compile JavaScript in accordance with the present invention.

FIG. 2 is a diagram exemplarily showing an internal configuration of a user terminal 200 in accordance with one example embodiment of the present invention.

FIG. 3 is a drawing exemplarily illustrating an internal configuration of a compilation performing part 220 in accordance with one example embodiment of the present invention.

FIG. 4 is a diagram exemplarily depicting a process of JavaScript included in a web application being compiled AOT and executed in accordance with one example embodiment of the present invention.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows:

Configuration of the Whole System

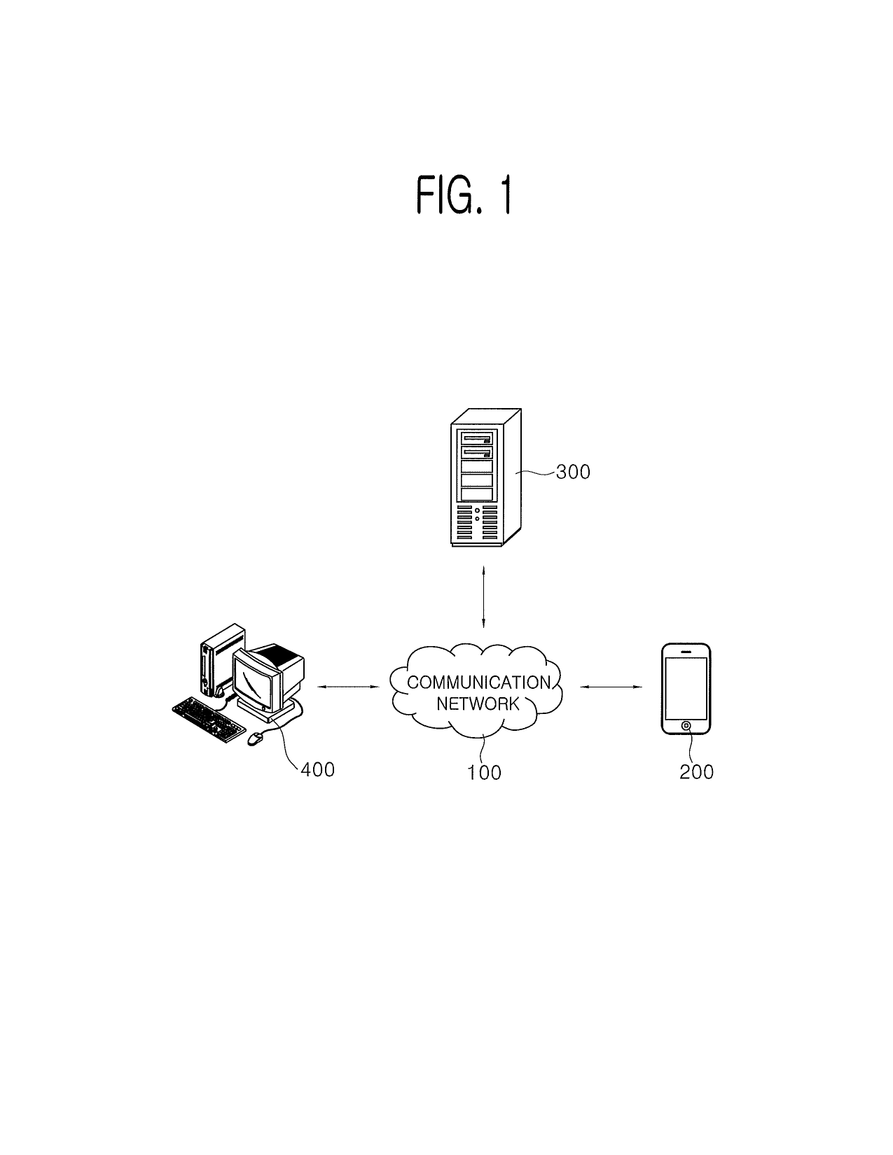

FIG. 1 approximately represents a configuration of the whole system to compile JavaScript in accordance with the present invention.

As illustrated in FIG. 1, the whole system in accordance with the present invention may include a communication network 100, a user terminal 200, a deployment server 300 and a developer terminal 400.

First, the communication network 100 in accordance with the present invention may be configured in a wireless form and may be also configured in forms of a mobile telecommunication network and an artificial satellite network and other diverse networks. More particularly, the network 100 in the present invention should be understood as a concept inclusive of all network services such as publicly known Wireless LAN (WLAN), Code Division Multiple Access (CDMA), Wideband Code Division Multiple Access (WCDMA), Global System for Mobile communications (GSM) or the like.

On one hand, the user terminal 200 in accordance with the present invention is a digital device which includes a function for accessing to the communication network 100 and then communicating with the deployment server 300 or the developer terminal 400. Such digital devices, including a personal computer, a smart phone, a table PC, a smart TV or a car telematics device, which have memory means and micro processors with a calculation ability, may be adopted as the user terminal 200 in accordance with the present invention. On the other hand, the user terminal 200 in accordance with the present invention may include a web runtime that may run a web application downloaded from the deployment server 300 or the developer terminal 400. Before the web application runs on the user terminal, the user terminal 200 in accordance with one example embodiment of the present invention may perform a function of AOT compiling JavaScript included in the web application by referring to a platform of the user terminal and creating a form of machine code executable thereon, i.e., AOT compilation.

The detailed explanation on an internal configuration of the user terminal 200 will be made in Section “Configuration of the User Terminal” below.

Next, the deployment server 300 in accordance with the present invention may communicate with the user terminal 200 or the developer terminal 400 through the communication network 100. More specifically, it may conduct functions of receiving and managing a variety of web applications from the developer terminal 400 and of deploying applications to the user terminal 200 at a request thereof.

Next, the developer terminal 400 in accordance with the present invention may communicate with the user terminal 200 or the deployment server 300 through the communication network 100. More specifically, it may conduct a function of packaging a variety of web applications developed by developers and transmitting them to the user terminal 200 or the deployment server 300.

Configuration of the User Terminal

The detailed explanation on an internal configuration and components of the user terminal 200 which performs important functions in order to implement the present invention in accordance with one example embodiment of the present invention will be made below.

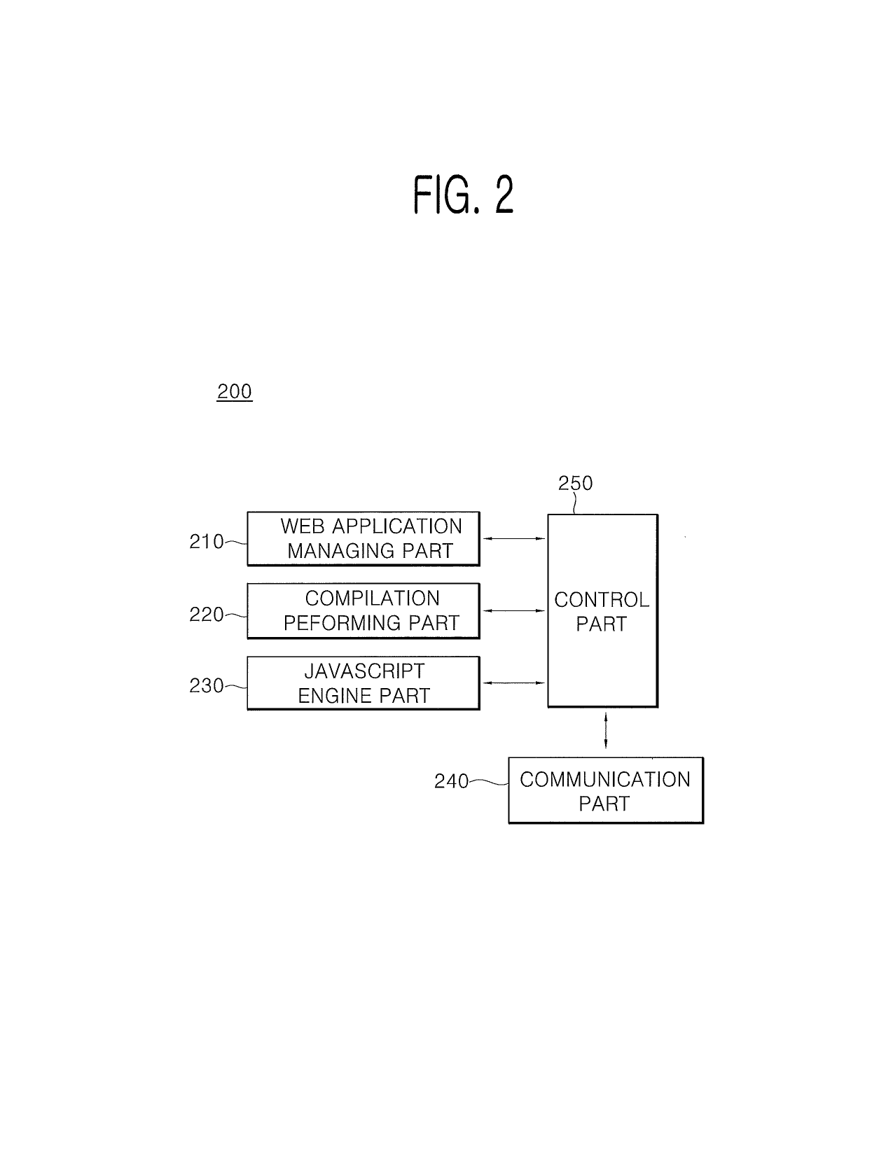

FIG. 2 exemplarily illustrates the internal configuration of the user terminal 200 in accordance with one example embodiment of the present invention.

By referring to FIG. 2, the user terminal 200 in accordance with one example embodiment of the present invention may include a web application managing part 210, a compilation performing part 220, a JavaScript engine part 230, the communication part 240 and a control part 250. In accordance with one example embodiment of the present invention, at least some of the web application managing part 210, the compilation performing part 220, the JavaScript engine part 230, the communication part 240 and the control part 250 may be program modules included in or, communicating with, the user terminal 200. Such program modules may be included in the user terminal 200 in a form of an operating system, an application program module and other program modules and they may be stored either in various storage devices well known to those skilled in the art or in a remote storage device capable of communicating with the user terminal 200. The program modules may include but not be subject to a routine, a subroutine, a program, an object, a component, and a data structure for executing a specific operation or a type of specific abstract data that will be described in accordance with the present invention.

First of all, the web application managing part 210 in accordance with one example embodiment of the present invention may perform a function of unpackaging a web application downloaded from the deployment server 300 or the developer terminal 400. Since the packaged web application generally includes JavaScript at a compressed state together with various contents including Hyper Text Markup Language (HTML), Cascading Style Sheets (CSS), images, videos and audios, and the web application in accordance with one example embodiment of the present invention may be unpackaged to leave JavaScript included therein to become compilable.

In accordance with one example embodiment of the present invention, the web application managing part 210 may conduct a function of installing the unpackaged web application on the user terminal 200.

Moreover, the compilation performing part 220 in accordance with one example embodiment of the present invention may perform a function of creating machine code or byte code by AOT compiling JavaScript included in the web application before the web application runs on the user terminal. For instance, the compilation performing part 220 in accordance with one example embodiment of the present invention will be able to perform a compilation while the web application is being installed on the user terminal 200 or a compilation on a background while the user terminal 200 is in an idle mode before the installed web application runs. But it is made clear that the point of compiling JavaScript in the present invention is not limited only to the exemplary method mentioned above and it may be changeable at any time within the scope of achieving the purpose of the invention for compiling JavaScript before a web application runs.

Furthermore, the compilation performing part 220 in accordance with one example embodiment of the present invention may compile JavaScript to a form of machine code executable in a platform by referring to a platform of the user terminal 200 where the web application will run, i.e., an operating system. Even though the deployment server 300 or the developer terminal 400 existing out of the user terminal 200 have left machine code for each of various kinds of platforms to be created by compiling JavaScript for each of them or a user personally does not select a web application suitable for the platform of his or her terminal, an effect will be hereby achieved that machine code suitable for the platform of the user terminal 200 is able to be simply created.

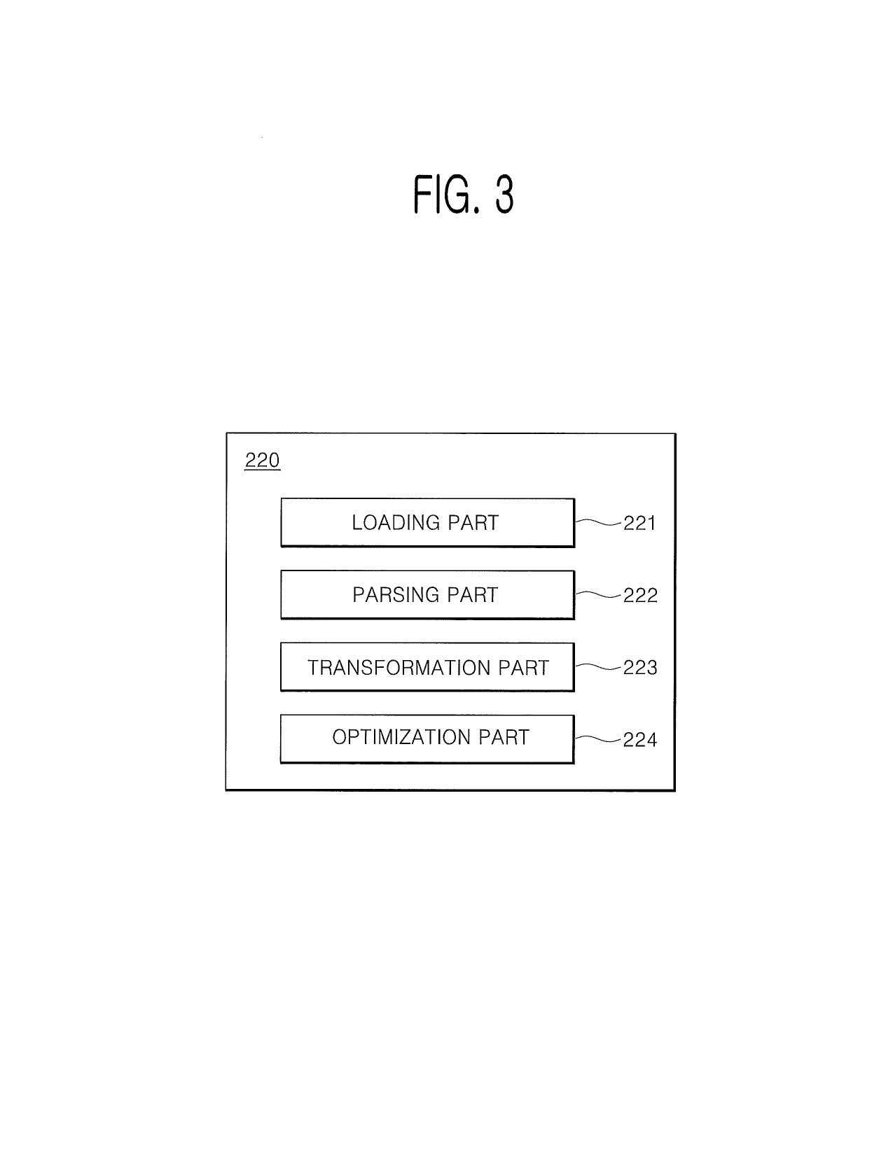

FIG. 3 exemplarily shows an internal configuration of the compilation performing part 220 in accordance with one example embodiment of the present invention.

By referring to FIG. 3, the compilation performing part 220 in accordance with one example embodiment of the present invention may include a loading part 221, a parsing part 222, a transformation part 223 and an optimization part 224. In accordance with one example embodiment of the present invention, at least some of the loading part 221, the parsing part 222, the transformation part 223 and the optimization part 224 may be program modules communicable with the user terminal 200. Such program modules may be included in the user terminal 200 in a form of an operating system, an application program module and other program modules, or they may be stored either in various storage devices well known to those skilled in the art or in a remote storage device capable of communicating with the user terminal 200. The program modules may include but not be subject to a routine, a subroutine, a program, an object, a component, and a data structure for executing a specific operation or a type of specific abstract data that will be described in accordance with the present invention.

In accordance with one example embodiment of the present invention, the loading part 221 may perform a function of loading a JavaScript source code and the parsing part 222 may carry out a function of parsing the loaded JavaScript source code and creating an abstract syntax tree (AST). While the transformation part 223 performs a function of transforming the source code into a form of machine code executable on the platform of the user terminal 200 by using the created AST, the optimization part 224 may accomplish a function of optimization including code optimization, static analysis, register allocation or the like.

By confirming the information on a JavaScript engine installed on the user terminal 200, the compilation performing part 220 in accordance with one example embodiment of the present invention may perform a compilation by using an AOT compiler fit for the engine if the user terminal 200 has the suitable compiler and carry out the compilation after downloading and installing a required AOT compiler from an external system if the user terminal 200 does not.

Besides, the compilation performing part 220 in accordance with one example embodiment of the present invention may execute a function of allowing the user arbitrarily or the user terminal 200 to automatically activate or deactivate the AOT compilation. In other words, in accordance with one example embodiment of the present invention, if the user arbitrarily, or the user terminal 200 automatically according to an operating circumstance, sets up a deactivation mode, the AOT compilation process, i.e., the process for compiling JavaScript may not be performed before the web application runs.

Next, if a request for executing the web application is entered, the JavaScript engine part 230 in accordance with one example embodiment of the present invention may conduct a function of executing machine code created by the compilation performing part 220. In accordance with one example embodiment of the present invention, the machine code may be executed by the JavaScript engine that includes a certain machine code loading part.

In accordance with one example embodiment of the present invention, other contents such as HTML, CSS and images that have been included in the web application will be able to be run by Web Core together with the machine code being executed.

Next, the communication part 240 in accordance with one example embodiment of the present invention may perform a function of making the user terminal 200 communicate with an external system such as the deployment server 300 and the developer terminal 400.

Lastly, the control part 250 in accordance with one example embodiment of the present invention may perform a function of controlling the flow of data among the web application managing part 210, the compilation performing part 220, the JavaScript engine part 230 and the communication part 240. In short, the control part 250 may control the flow of data from outside or among the components of the user terminal 200 to allow the web application managing part 210, the compilation performing part 220, the JavaScript engine part 230 and the communication part 240 to perform their unique functions.

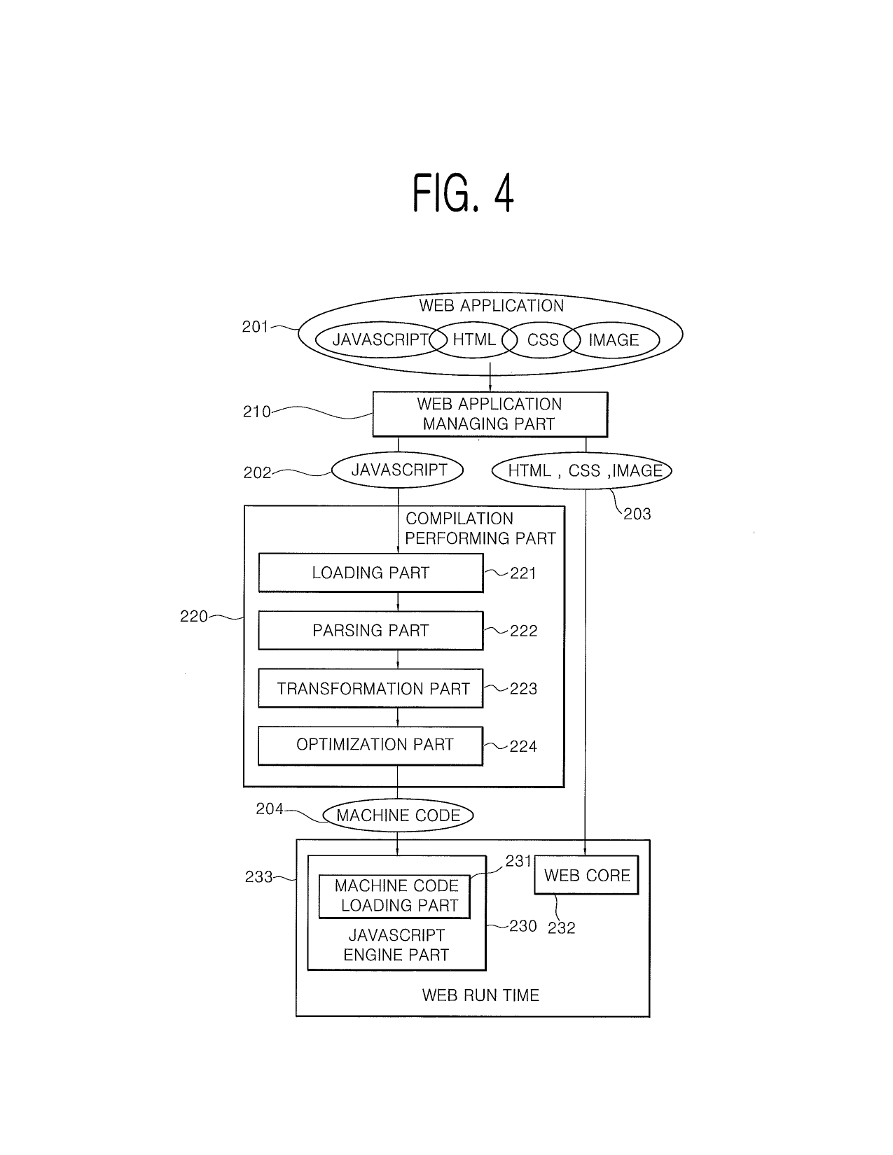

FIG. 4 exemplarily depicts a process of JavaScript included in a web application being compiled AOT and executed in accordance with one example embodiment of the present invention.

By referring to FIG. 4, the web application 201 packaged while containing the contents such as JavaScript, HTML, CSS, and images may be unpackaged by the web application managing part 210. Accordingly, JavaScript 202 once included in the web application 201 may separate from the other contents 203 such as HTML, CSS, and images and become in a mode of compilation.

By referring to FIG. 4, JavaScript 202 may be compiled by the compilation performing part 220 and become transformed into machine code 204. More particularly, the compilation process may be performed by a loading part 221, a parsing part 222, a transformation part 223 and an optimization part 224.

By referring to FIG. 4, if a request for executing the web application 201 is entered, the machine code 204 compiled and created from the JavaScript 202 may be executed by the JavaScript engine part 230 in Web Run Time 233 where the machine code may be loaded by a machine code loading part 231 in the JavaScript engine part 230. The other contents 203 in the web application 201 may be performed by Web Core 232 in the Web Run Time 233.

As shown above, in accordance with one example embodiment of the present invention, even though the deployment server 300 or the developer terminal 400 outside of the user terminal 200 does not create machine code for each of various kinds of platforms by compiling JavaScript suitable for each of them or the user does not directly select a web application suitable for the platform of his or her terminal, a favorable effect may be additionally achieved that the machine code suitable for the platform of the user terminal 200 where the web application will run is able to be automatically created.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variation equal or equivalent to the patent claims pertain to the category of the thought of the present invention.

What is claimed is:

1. A method for compiling JavaScript included in a web application ahead of time (AOT), comprising the steps of:
(a) allowing a user terminal to acquire and unpackage the web application; and
(b) allowing the user terminal to compile JavaScript included in the web application by referring to a platform thereof and create a form of machine code executable thereon, before the web application runs thereon.

2. The method of claim 1, wherein the step (b) includes the step of:
(b1) loading a JavaScript source code;
(b2) parsing the JavaScript source code and creating an abstract syntax tree (AST); and
(b3) transforming the JavaScript source code into a form of machine code executable on the platform of the user terminal by using the AST.

3. The method of claim 2, wherein the step (b) further includes the step of:
(b4) optimizing the machine code.

4. The method of claim 1, wherein, at the step (b), the web application compiles the JavaScript while being installed on the user terminal.

5. The method of claim 1, wherein, at the step (b), the user terminal compiles the JavaScript while being in an idle mode.

6. The method of claim 1, wherein, at the step (b), if being decided not to have a compiler used to compile the JavaScript, the user terminal downloads the compiler from an external system.

7. The method of claim 1, wherein performance of the step (b) depends on a setting of the user terminal.

8. The method of claim 1, further comprising the step of (c) executing the machine code if a request for executing the web application is entered.

9. A terminal for compiling JavaScript included in a web application ahead of time (AOT), comprising:
a web application managing part for unpackaging an acquired web application; and
a compilation performing part for compiling JavaScript included in the web application by referring to its platform before the web application runs and creating a form of machine code executable on its platform.

10. The terminal of claim 9, wherein the compilation performing part includes:
a loading part for loading the JavaScript source code;
a parsing part for parsing the JavaScript source code and creating an abstract syntax tree (AST); and
a transformation part for transforming the JavaScript source code into a form of machine code executable on its platform by using the AST.

11. The terminal of claim 10, wherein the compilation performing part further includes an optimization part for optimizing the machine code.

12. The terminal of claim 9, wherein the compilation performing part compiles the JavaScript while the web application is installed on itself.

13. The terminal of claim 9, wherein the compilation performing part compiles the JavaScript while being in an idle mode.

14. The terminal of claim 9, wherein, if being decided not to have a compiler used to compile the JavaScript, the compilation performing part downloads the compiler from an external system.

15. The terminal of claim 9, wherein an operation of the compilation performing part is decided by a setting thereof.

16. The terminal of claim 9, wherein, if a request for executing the web application is entered, the compilation performing part includes a JavaScript engine part for executing the machine code.

17. One or more computer-readable media having stored thereon a computer program that, when executed by one or more processors, causes the one or more processors to perform acts including:
allowing a user terminal to acquire and unpackage the web application; and
allowing the user terminal to compile JavaScript included in the web application by referring to a platform thereof and create a form of machine code executable thereon, before the web application runs thereon.
